(19) United States
(12) Patent Application Publication
(10) Pub. No.: US 2005/0246745 A1
(43) Pub. Date: Nov. 3, 2005

(54) Integral digital asset management and delivery system and network based DVD delivery system

(76) Inventors: Mark Andrew Hirsch, New York, NY (US); David Wray Stickford, New York, NY (US)

Correspondence Address: BURNS & LEVINSON LLP, 1030 15TH STREET NW, SUITE 300, WASHINGTON, DC, 20005-1501, US

(21) Appl. No.: 11/108,382

(22) Filed: Apr. 18, 2005

Related U.S. Application Data
(60) Provisional application No. 60/563,501, filed on Apr. 16, 2004.

(51) Int. Cl. H04N 7/18

(52) U.S. Cl. 725/74

(57) ABSTRACT

This invention relates generally to a system and method for the creation of authored DVDs and CDs, and more particularly relates to a system and method for implementing a digital asset management system for the selection of media, metadata and authoring information to ensure proper development of the DVD/CD within a local network environment and in a distributive fashion by incorporating the internet.

### CROSS REFERENCE TO RELATED APPLICATIONS

This application claims the priority under 35 U.S.C. § 119 of provisional application Ser. No. 60/563,501 entitled Integral Digital Asset Management and Delivery System and Network Based DVD Delivery System” filed Apr. 16, 2004.

### FIELD OF THE INVENTION

This invention relates generally to a system and method for the authoring, production and delivery of authored DVDs, and, more particularly relates to a system and method for implementing a digital asset management system to enable the selection of media, metadata and authoring information to ensure proper development of the DVD within a local network environment and in a distributive fashion by incorporating the Internet. Furthermore, this invention integrates these capabilities and automates the process such that human involvement is not a requirement of the DVD authoring, production and delivery processes.

### BACKGROUND OF THE INVENTION

The Digital Video Disc (DVD) player has replaced the Video Cassette Recorder (VCR) as the most widely adopted consumer device in history. As one of the most popular technology devices in the consumer market, it has naturally gained adoption into the commercial markets as well. Many organizations associated with the video and presentation industries have begun to discard their traditional tape-based systems in favor of digital systems with a significant emphasis on delivery via DVD.

There are dozens of software packages, generally categorized as DVD authoring systems that can create the “authored DVD.” The authored DVD is the digital content that is capable of producing linear and non-linear playback via a DVD player as well as a DVD-equipped computer. These applications require the participation of a human editor or artist to actually author the DVD material. This authoring process is typically a time-consuming and laborious process inclusive of many steps. The playback of the “authored DVD” may be interactive, as the DVD specification enables this activity. This is in direct contrast to the “DVD-ROM” which is a large storage medium without any integrated, interactive playback mechanisms.

At the same time as the DVD is gaining popularity and widespread adoption, the increasing utilization of computers has generated an ever-increasing amount of digital data for individuals and corporations to store, retrieve, manipulate, and share. Having a central catalog of this digital content enables users to share not only the content but also associated information about that content, hereafter referred to as “metadata.”

Corporations and individuals recognize the multiple benefits of a shared repository. As corporations evaluate their digital asset management needs, the focus has been on the taxonomies of the metadata and determining methodologies for retrieving the metadata. There has been limited focus on the actual retrieval and utilization of these files. The adoption of the digital asset management systems has been restrained because of a variety of reasons, including the high price of these systems as well as an incomplete understanding of a client's workflow as it relates to the utilization of the particular assets.

In the case of media files (including but not limited to video, audio, and still images), the digital media asset management systems have focused on the collection of the media itself, the collection of associated metadata, and the ability to enable multiple users to access the information simultaneously. Systems generally have been weak to define or implement methodologies for the media content to be utilized and manipulated. Specifically unaddressed has been the ability to create “authored DVD” and hybrid DVD and CD discs with adherence to the DVD specification. Because organizations contemplating incorporation of the media asset management system have not previously had an opportunity to generate authored DVDs directly from their systems, these organizations have had less need for the digital DVD players. Because they have less need for the digital DVD players, they have had less justification for the implementation of the media asset management system. There is an obvious stalemate here, and it is the intent of our invention to solve this problem.

Additionally, since the digital media asset management system operates on a network, the users may be located anywhere in the world with network access. Thus, it is becoming apparent that users will request their media delivered to other networked locations away from the central repository. It is also the intent of this invention to enable the distribution of authored DVD content to remote locations accessible via a network.

### SUMMARY OF THE INVENTION

The invention relates to system for automated digital video disc recording and printing, said system comprising a media repository connected to a wide area or local area network; a server for extracting and storing digital data from the media asset management system for the compilation of client-desired digital video disc projects, wherein the server is operationally linked to the network; a digital video disc recording device for receiving said projects from the server; a digital video disc printing device for printing and affixing a label on to a digital video disc; and at least one client computing apparatus connected to the network, wherein the digital video disc recording device and printing device may be physically attached to a client computing apparatus and alternatively remotely attached to a client computing apparatus via the network.

A second embodiment of the invention relates to a system for automated digital video disc recording and printing, said system comprising a wide area or local area network capable of receiving data from and transmitting data to at least one remotely situated client computing apparatus; a media repository connected to said network; a server for extracting and storing digital data from the media asset management system for the compilation of client-desired digital video disc projects, wherein the server is operationally linked to the network; a digital video disc recording device for receiving said projects from the server; a digital video disc printing device for printing and affixing a label on to a digital video disc; and at least one client computing apparatus capable of remotely connecting to the network, wherein the digital video disc recording device and printing device may be physically attached to a client computing apparatus and alternatively remotely attached to a client computing apparatus via the network.

The present invention also relates to a method for digital video disc recording and printing, said method comprising collecting media data elements and metadata information from a media asset management system; maintaining the media data elements and metadata in a database within the media asset management system; receiving the media and metadata into a designated server; selecting media and digital video disc configurations via an HTML interface; creating a digital video disc project from the selected configurations; submitting a digital video disc project order for storage within the server's database; verifying the order; transcoding the media to a specified digital video disc format; designing a menu page for the digital video disc project; programming menu button functionality on the menu page; programming navigation of the digital video disc project; creating a digital video disc image; sending the image to a local or remote digital video disc recorder; recording the image; using the metadata information to print a disc label; and sending an email notification to selected users.

A second embodiment of the inventive method for automated digital video disc recording and printing comprises collecting media data elements and metadata information from a media asset management system; maintaining the media data elements and metadata in a database within the media asset management system; receiving the media and metadata into a designated server; specifying media and digital video disc configurations; submitting an XML order for the digital video disc project from the specified configurations; verifying the order; transcoding the media to a specified digital video disc format; designing a menu page for the digital video disc project; programming menu button functionality on the menu page; programming navigation of the digital video disc project; creating a digital video disc image; sending the image to a local or remote digital video disc recorder; recording the image; using the metadata information to print a disc label; and sending an email notification to selected users.

It is an object of the present invention to overcome the above-referenced and other known problems existing with the current state of creating authored DVDs from content stored within a media asset management system via an automated process and the distribution of the information and remote creation of the final DVD discs. Another object of the present invention is to combine concepts of asset management, media files preparation, DVD authoring, and network-based distribution of the media to DVD recording devices to allow a complete automated workflow for producing authored DVD discs. By automating the process and removing any required human involved, the invention can easily provide a complete process that delivers fully-authored DVDs anywhere via a digital network.

Still another object of the present invention is to incorporate a specialized communication protocol, this digital network can even be extended to the public Internet. Accordingly, just as a written document can be digitally transmitted via the “fax protocol” using the standard telephone system, this invention enables an authored DVD, not only to be created automatically, but also to be delivered via the standard Internet. The scope of this invention includes the overall system of creating the DVD, as well as the individual elements of integrating with the asset management system and managing the network delivery of the DVD image.

It is to be understood that both the foregoing general description and the following detailed description are exemplary and explanatory only and are not restrictive of the invention as claimed.

### BRIEF DESCRIPTION OF THE DRAWINGS

FIG. 1 is a data flow chart in accordance with the present invention.

FIG. 2 is a diagram of the system architecture in accordance with the present invention.

FIG. 3 is a process flow chart in accordance with the present invention.

FIG. 4 is a screen shot example of one page in an installation sequence used for implementing the present invention.

FIG. 5 is a screen shot example of a second page in an installation sequence.

FIG. 6 is a screen shot example of a license agreement presented to the user for use of the present invention.

FIG. 7 is a screen shot example of a video setting administration menu

FIG. 8 is a screen shot example of a video setting preset configuration editing page.

FIG. 9 is a screen shot example of a contact person administration menu

FIG. 10 is a screen shot example of a menu presented to a user for entering company information.

FIG. 11 is an example of an interface presented to the user for entering company location information.

FIG. 12 is an example of a project creation and editing interface in accordance with the present invention.

FIG. 13 is an example of an interface for adding clips and data.

FIG. 14 is an example of an interface for searching for clips and data within a defined media asset management system.

FIG. 15 is an example of an interface presented to the user for modifying overall application configurations including enabling electronic mail flow to and from the DVD SelectNet™ system of the present invention.

FIG. 16 is a screen shot example of the data directory administration interface.

FIG. 17 is a screen shot example of the data directory editing interface.

FIG. 18 is a screen shot example of a message queue component configuration interface in accordance with an embodiment of the present invention.

FIG. 19 is a screen shot example of a menu style administration interface in accordance with the present invention.

FIG. 20 is a screen shot example of a menu style creation interface in accordance with the present invention.

FIG. 21 is a screen shot example of a label style administration menu.

FIG. 22 is an example of the project viewing interface in accordance with an embodiment of the present invention.

FIG. 23 is a screen shot example of a DVD creation menu in accordance with the present invention.

FIG. 24 is a screen shot example of the interface used to perform a search of the query conditions.

FIG. 25 is a screen shot example of the interface used to assess and add video media to the authored DVD in accordance with the present invention.

FIG. 26 is a screen shot example of a playlist modification interface in accordance with the present invention.

FIG. 27 is an example of an interface used by an operator to assess application performance conditions.

FIG. 28 is another example of an interface used by an operator to assess application performance conditions.

FIG. 29 is a screen shot of a menu style interface presented to an internet user of the present invention.

FIG. 30 is a screen shot of a project viewing interface presented to an internet user of the present invention.

FIG. 31 is a screen shot of an additional exemplary project viewing interface presented to an internet user of the present invention.

FIG. 32 is a screen shot of a project data editing interface presented to an internet user of the present invention.

### DESCRIPTION OF THE PREFERRED EMBODIMENT

Reference will now be made in detail to embodiments of the invention, examples of which are illustrated in the accompanying drawings. Wherever possible, the same reference numbers will be used throughout the drawings to refer to the same or like parts.

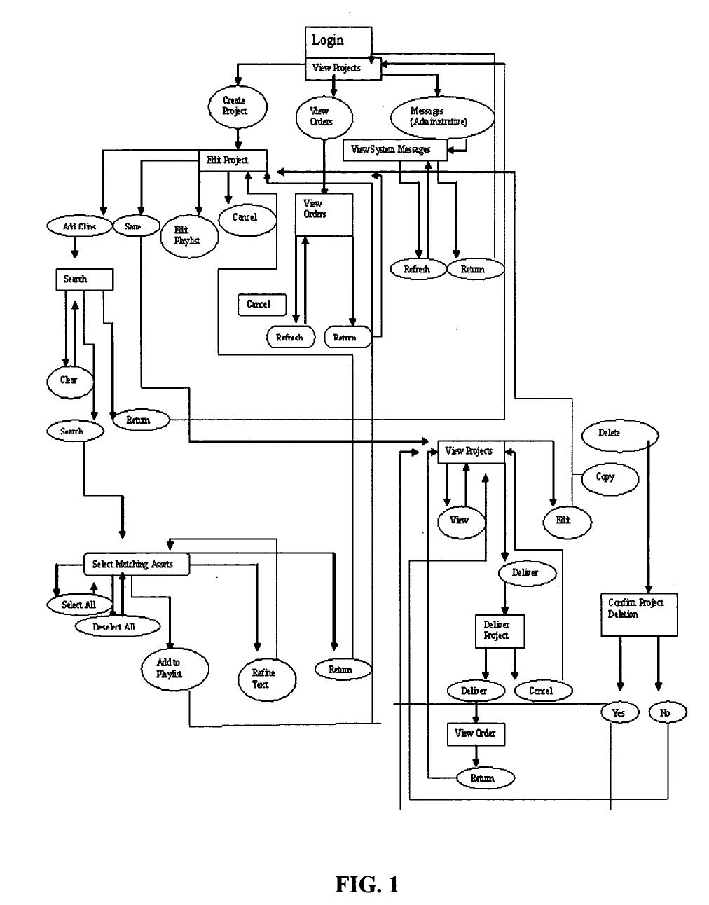

DVD SelectNet™ is a system for automatically creating DVD and CD discs that incorporates media & metadata referenced by a digital media asset management tool. FIG. 1 depicts a data flow chart of the user inputs and outputs of the system as described herein. This Figure will be referenced in further detail throughout the specification.

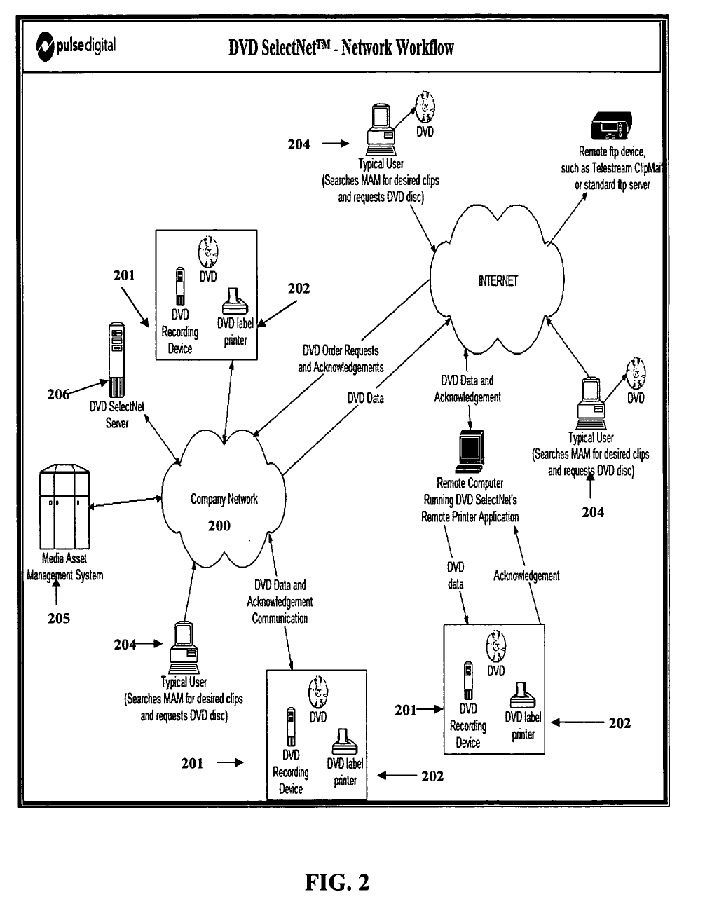

The system also coordinates the recording of these discs on DVD recording 201 & printing devices 202 situated at any network location 200 with access to the Internet, as illustrated in FIG. 2. DVD SelectNet™ utilizes a number of technologies to achieve the intended goal. As illustrated in FIG. 2, a user 204 may enter his or her company's network 200, wherein the user may search for digital media clips that he or she wishes to incorporate into a DVD.

The system of the present invention enables an organization to collect its digital media in a centralized repository within a company's network 200, along with associated metadata. This task is accomplished through the bundling and integration of various technology products within said inventive system. The Portfolio Server by Extensis is one type of digital asset management system that can hold the metadata. Companies that offer products that are potential alternatives to the Extensis product are numerous and include, but are not limited to: Canto, IBM, Documentum, Artesia/OpenText, Autonomy/Virage, Pictron, and NorthPlains.

In an additional embodiment of the present invention, Windows operating system folders are used instead of an external media repository 205 to hold the media. The system of the present invention uses the operating system folder names as the metadata that is searched.

In the preferred embodiment, the inventive system can easily integrate with other media asset management systems 205 by utilizing an extensible markup language (XML) file as the communication device. Said systems interact with DVD SelectNet™ via the XML order protocol. The user implements the external system to search & request the disc. The order is translated to XML and passed to DVD SelectNet™. The inventive system continually monitors a folder within network 200 for the presence of the XML file. When the XML file is received, the system begins processing based on the information contained with the XML file, which must adhere to a specification defined for this invention. In this manner, DVD SelectNet™ still transcodes the media, builds the menu pages, authors the interactivity, records the disc, prints the disc label and notifies the user of completion or error.

The system of the present invention also enables a user 204 located anywhere to log-in, search against the media repository, select the desired media, provide delivery information, and trigger the process. By submitting requested information, the user defines the media & designs to be used within the final authored DVD and the information related to disc's delivery. This process is shown in FIG. 1.

After logging in to the system, the user has the option of creating a new project, viewing existing projects or accessing the message administrative component to check any messages generated by the system for the user's review. After the user has completed the processes pertaining to any one of the three above-referenced objects, he or she may return back to the initial interface to select one of the two remaining options not previously selected.

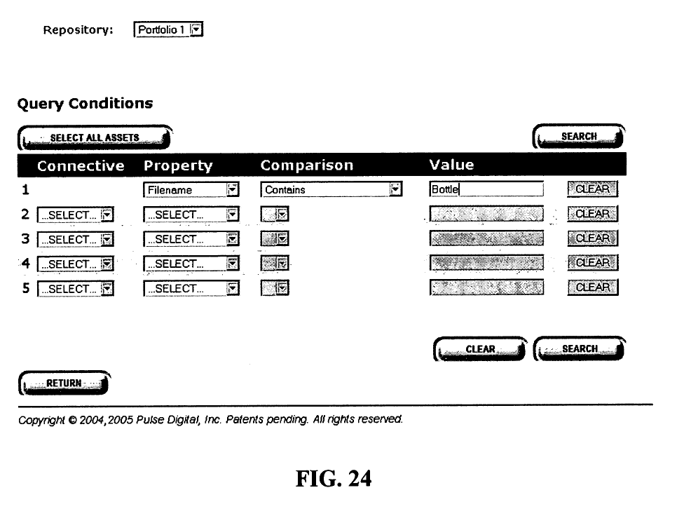

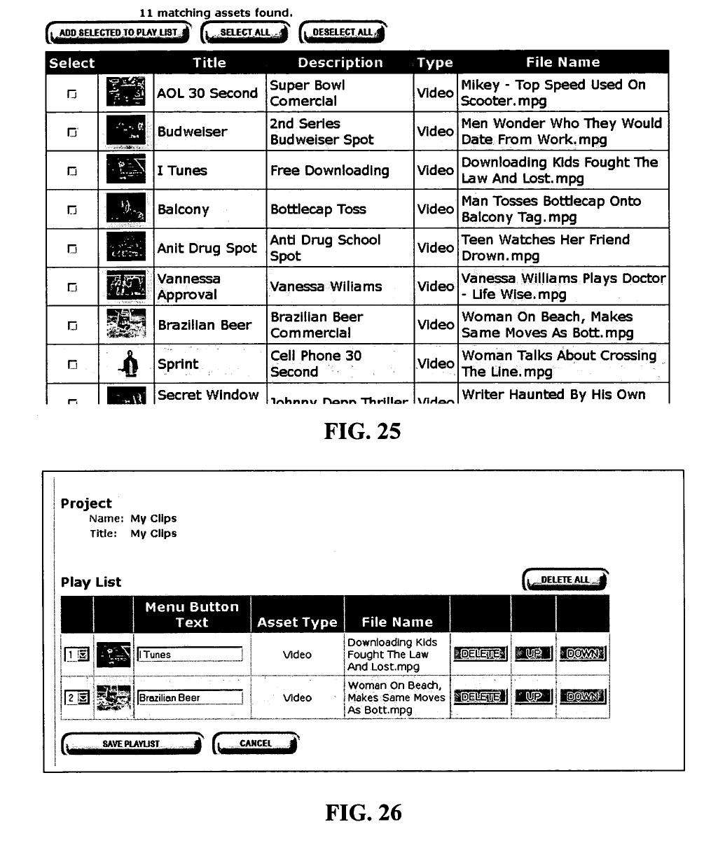

If the user chooses to create a project, the user searches available clips within the media repository to add to the DVD playlist. When a desired amount and type of clips are selected, the user may select other assets for addition to the DVD. FIG. 24 is illustrative of a query conditions interface in which a user can choose from a plurality of assets to complement the selected clips. FIG. 25 presents an exemplary user interface for adding desired assets to the user's playlist.

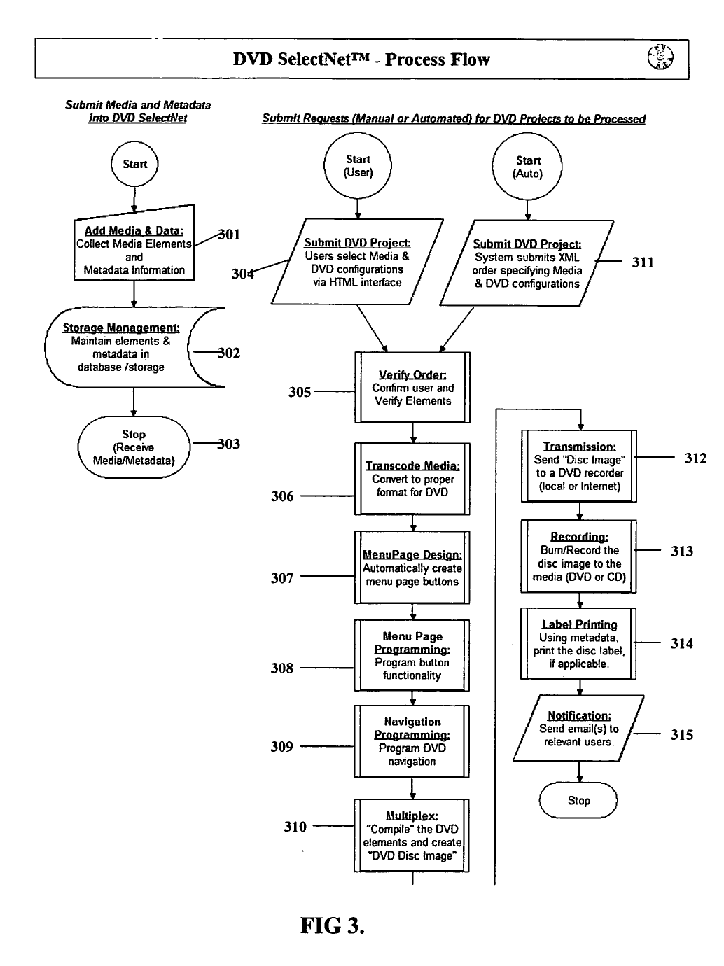

Additionally, the user may redefine the textual message or messages that are shown along with the selected clip. The project creation sequences described above are referenced in the media element and metadata information collection step 301 of FIG. 3. Referring back to FIG. 1, the user may edit the project and the selected playlist at his or her choosing. An exemplary playlist screen is show in FIG. 26 containing the numerical order assigned to each selected clip, the text of the menu button, the asset type (e.g. video), the file name, and deletion and scrolling buttons.

With respect to FIG. 3, Step 302 follows in which the user maintains elements and metadata in the accompanying database or storage component. In FIG. 1, this step is depicted in the saving of the project to the DVD Select Net™ system. Once this has been completed, step 303 terminates the project creation sequence as DVD SelectNet™ prepares to receive the selected media and metadata to be transferred to the DVD.

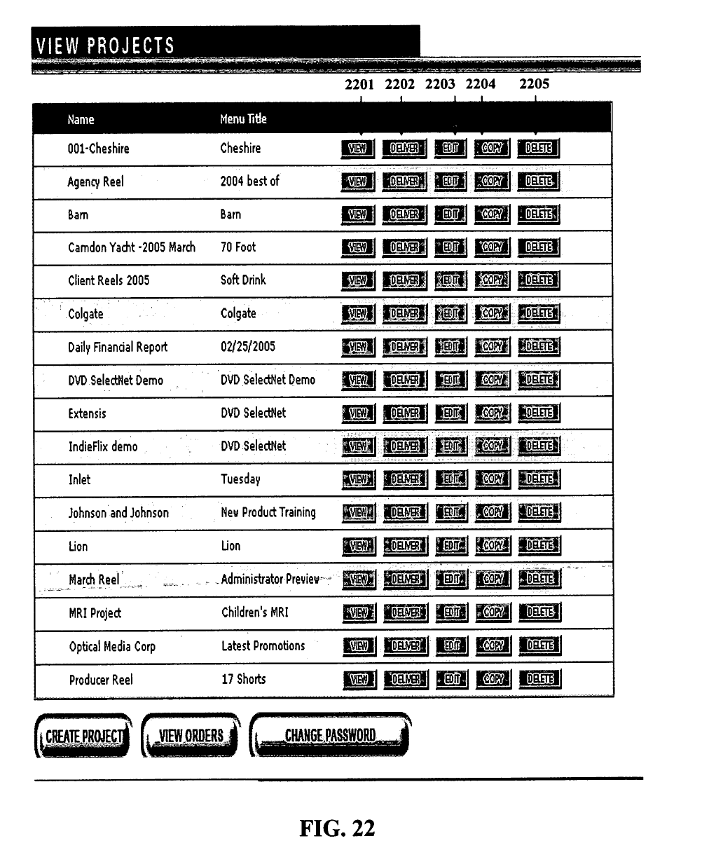

In FIG. 1, the user subsequently views the project and ultimately delivers the order to be processed. It should be noted that FIG. 22 depicts an example of a screen shot interface viewable by the user, and which shows a listing of all projects created by the user. The user implements delivery via the “deliver” button 2202. It should also be noted that the user may opt to choose viewing button 2201, editing button 2203, copying button 2204, or deletion button 2205 as he or she implements various components of the inventive system. After the user submits the requested information via step 304, the order is verified in step 305. The media clips are then retrieved and converted to the required format for DVD.

Configuration of the various media elements, such as audio & video, to conform to the DVD specification is performed in step 306. The media transcoding process is accomplished through the use of AuthorScript software modules developed by Sonic Solutions of Marin County, California. AuthorScript enables the inventive system to transcode the media, construct the menu page & interactivity and create the disc image. Other toolsets exist which provide similar functionality, including but not limited to technologies offered from companies such as Main Concepts, Padus, Inc., AutoDesk, Telestream, Anystream, and Microsoft, for example. The configuration of the transcoding parameters within the inventive system ensures adherence to the DVD specification.

After converting the media to MPEG-2 elementary streams, the digital DVD is created by ‘authoring’ the DVD. This means assembling all of the elements and creating a file which is effectively a compilation of the video, audio, menu pages, background graphics, menu button graphics, and interactive programming. This final DVD image file will eventually be recorded to the DVD or CD disc.

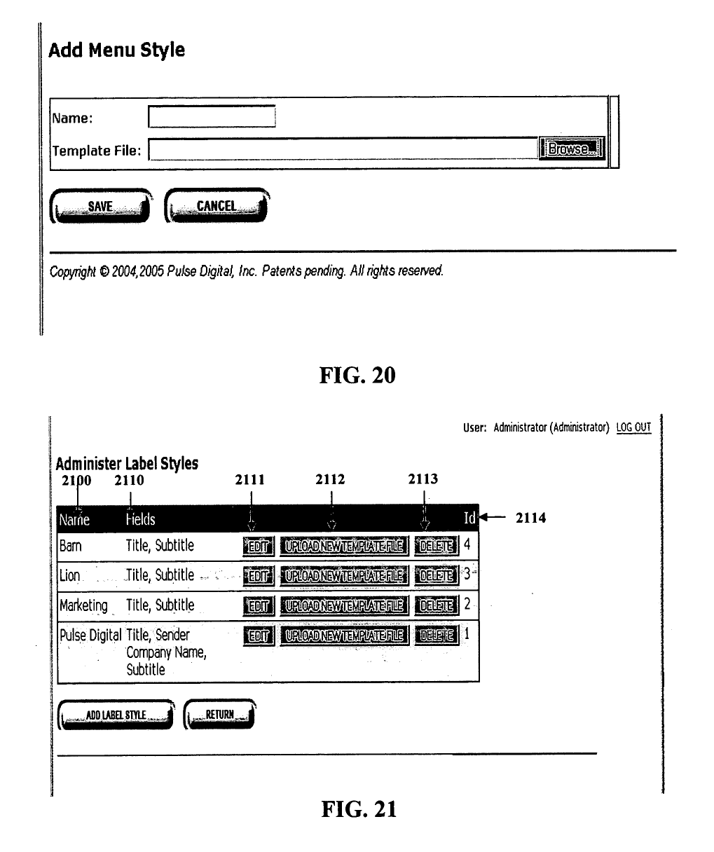

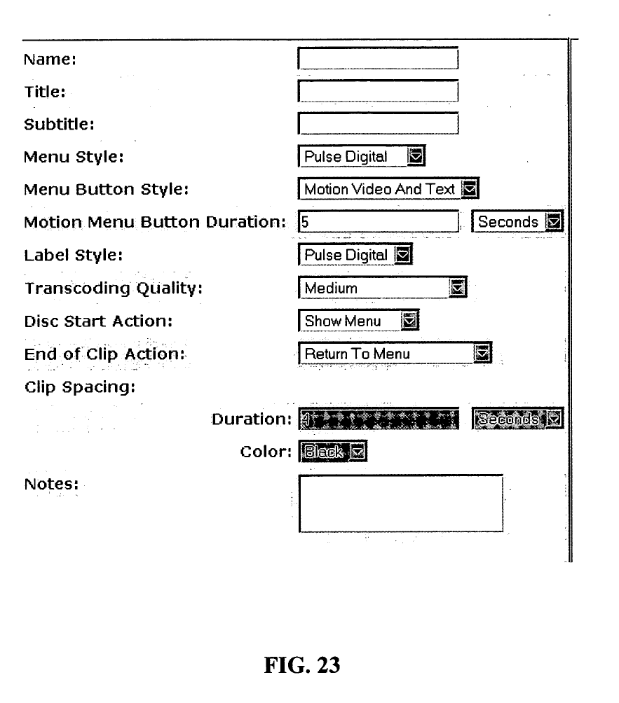

Details of the development of the graphic menu page via the “Menu Page Design” step 307 are presented herein. Within step 307, the system of the present invention automatically creates menu page buttons for the user to program in the subsequent step. An example of a menu page design is illustrated in FIG. 23. Programming of the interactive menu page (“Menu Page Programming”) occurs in step 308. Therein, the user programs the functionality of the displayed menu buttons. FIGS. 19 and 20 depict exemplary screen shots of the interfaces presented to the user for adding and administering menu styles.

Programming of the actual navigation functionality of the DVD (“Navigation Programming”) occurs in step 309 of FIG. 3. Multiplexing or compiling of all of the media and programming elements into a single “DVD image” (“Multiplexing”) in preparation for recording onto the disc media takes place in step 310. The transmission of the DVD image to the DVD recorder, if the DVD is not being recorded on the local computing machine that completed the multiplexing, is referenced as “Transmission” step 312.

Recording or “burning” the digital DVD image onto the blank media (“Recording”) occurs in step 313. Step 314 uses the metadata to printing a label on the DVD disc (“Label Printing”). This step may only be implemented if it is supported and enabled by the user's hardware. Finally, the authoring process is completed by notifying the user (i.e. sender and/or receiver) that the DVD project is complete (“Notification”). Notification is referenced in step 315 of FIG. 3.

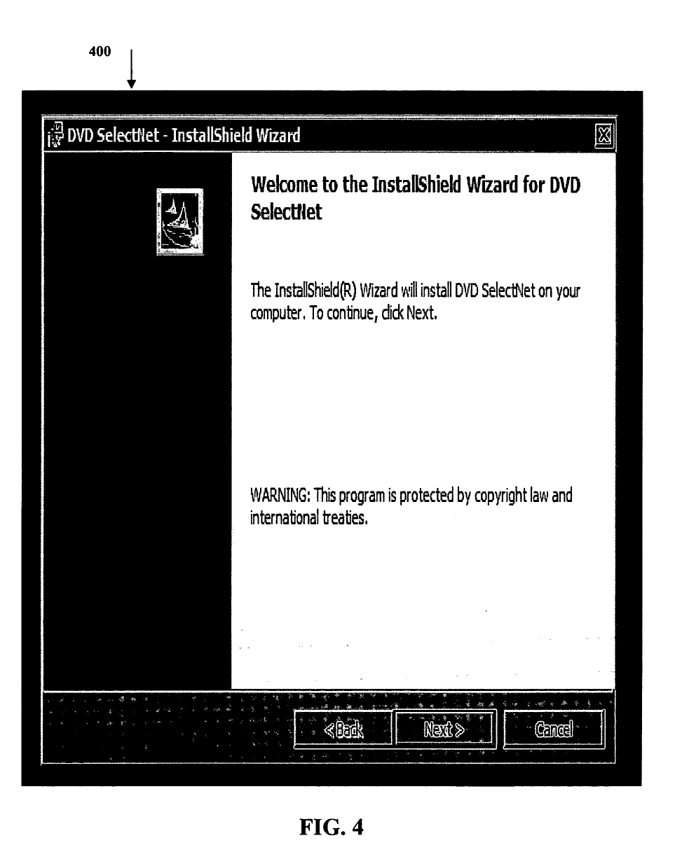

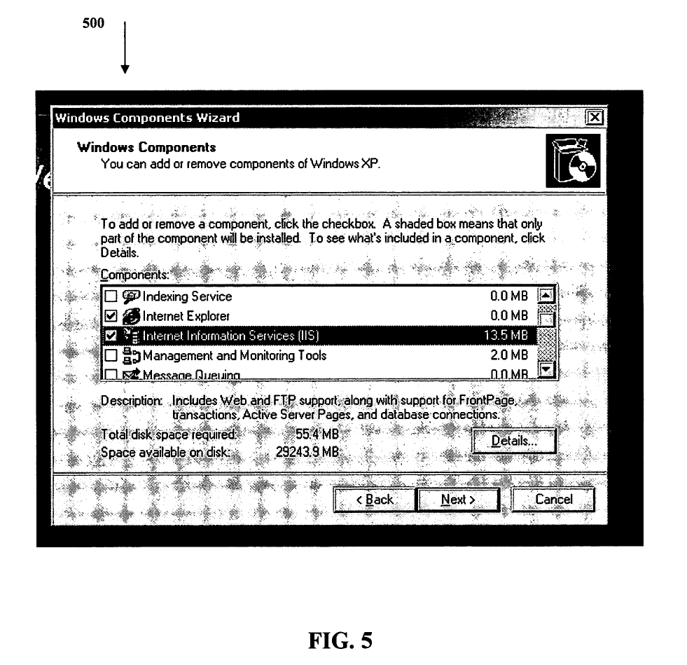

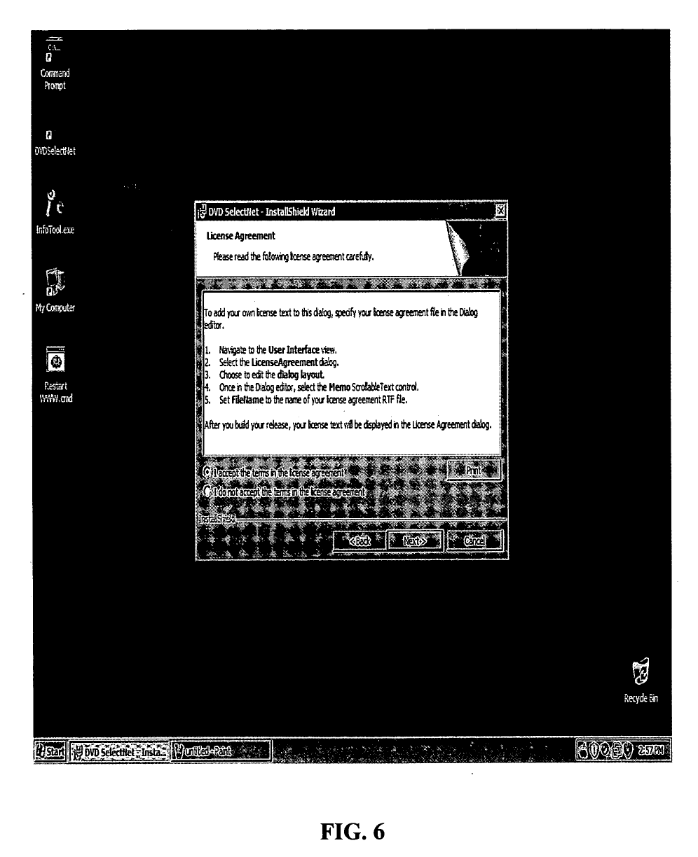

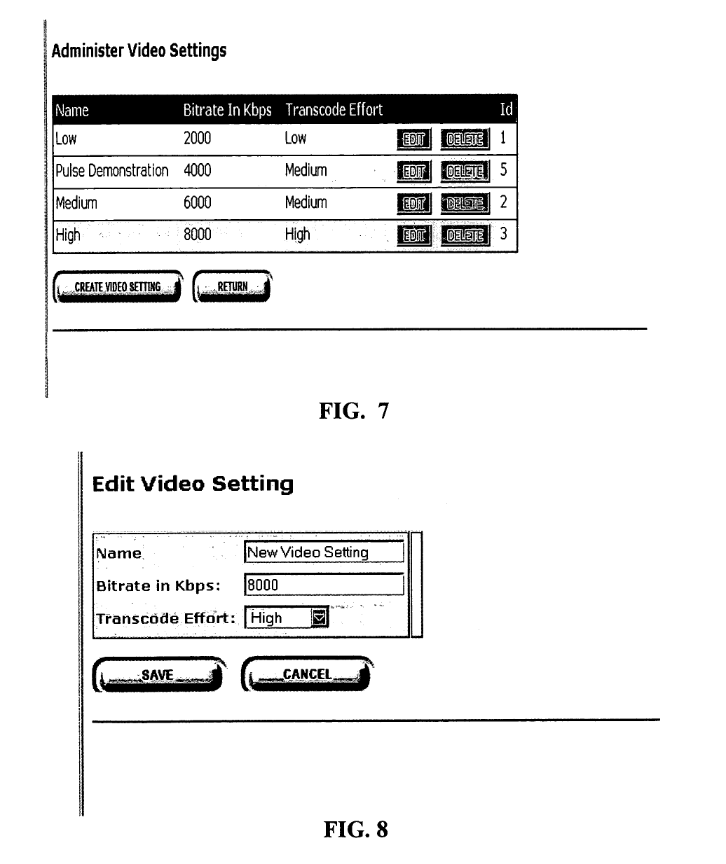

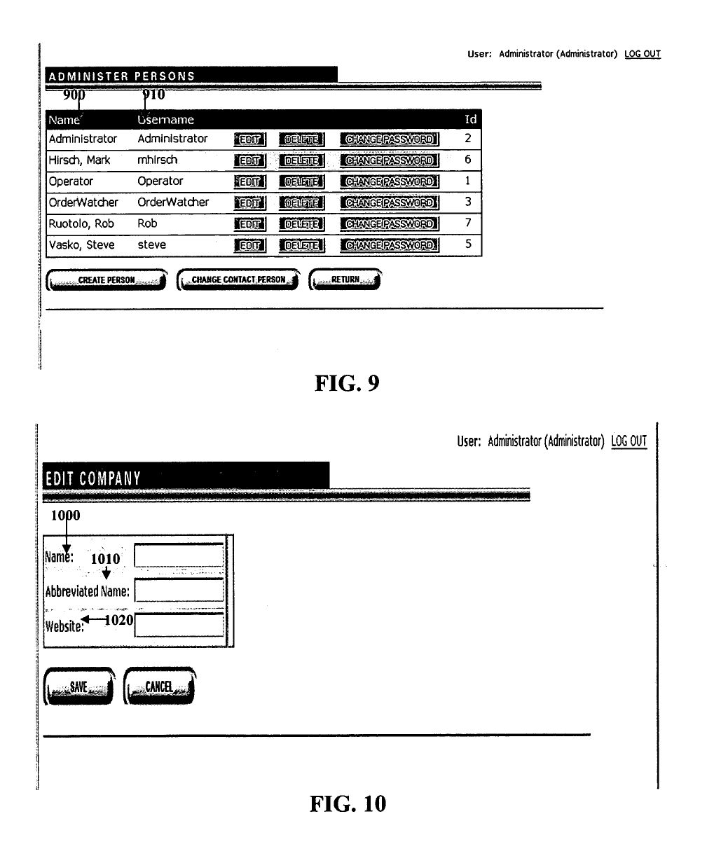

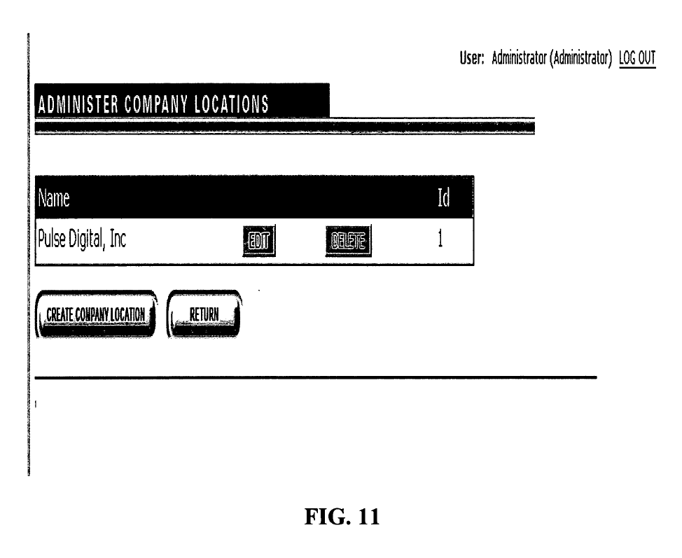

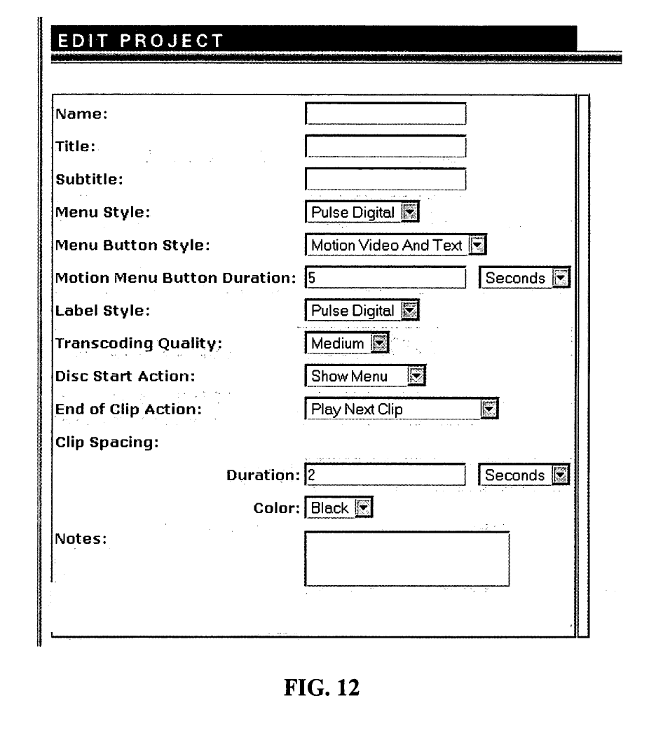

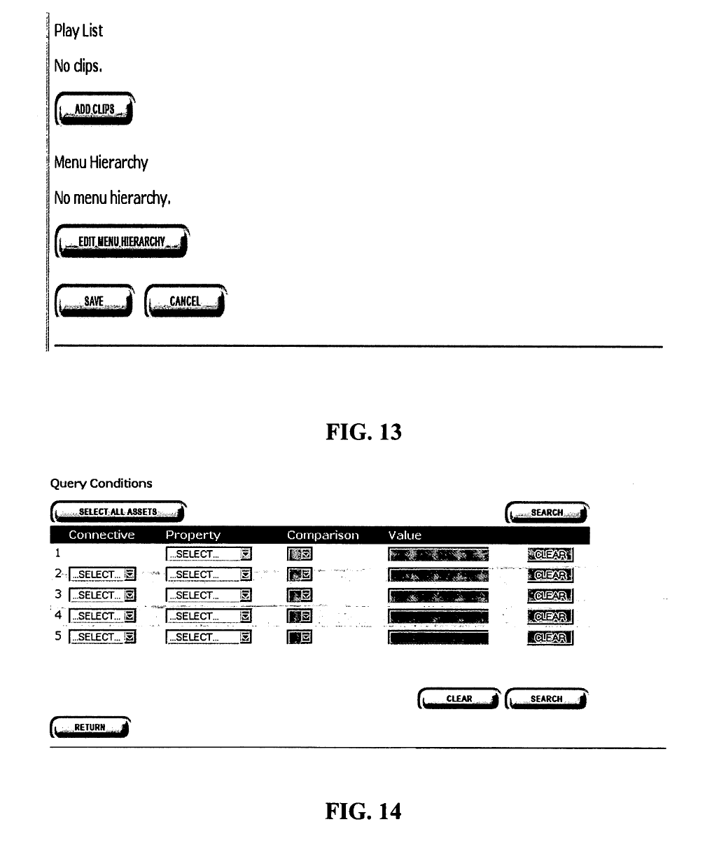

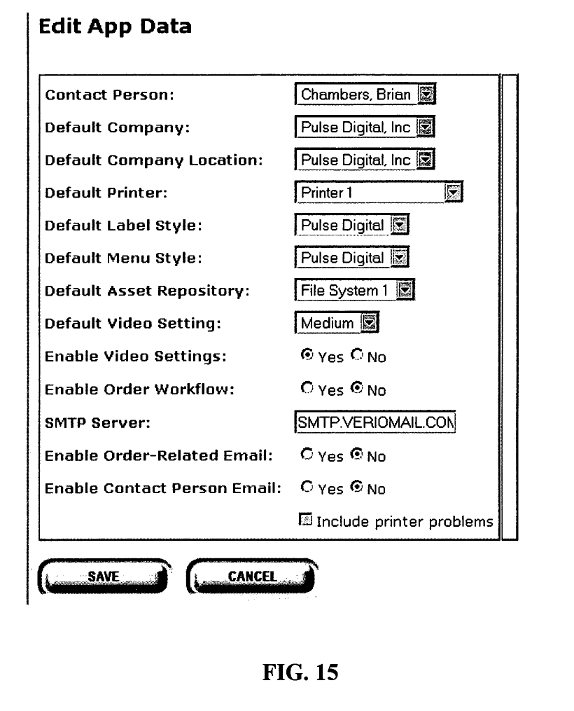

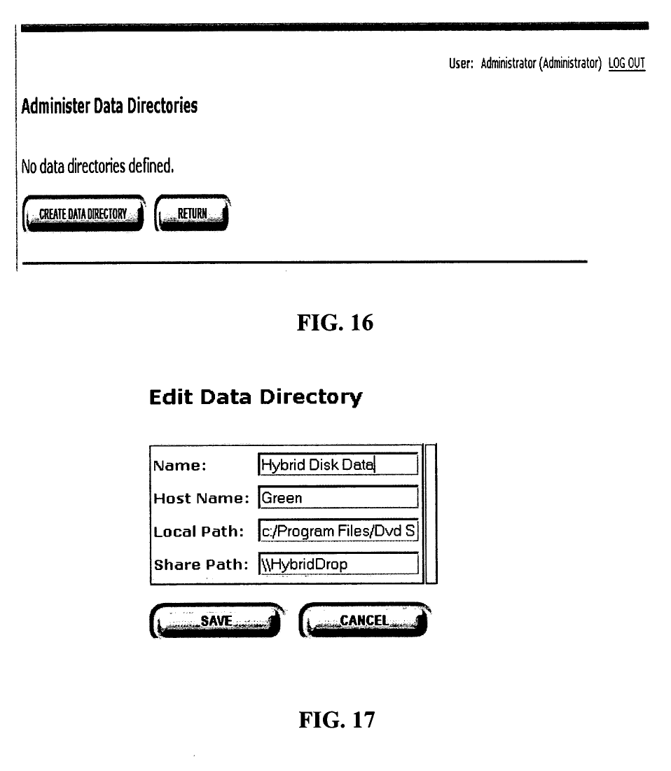

FIGS. 4, 5, and 6 depict examples of the installation 400 and 500 and licensing agreement 600 acceptance interfaces presented to the user when installing the DVD SelectNet™ system of the present invention for the first time.

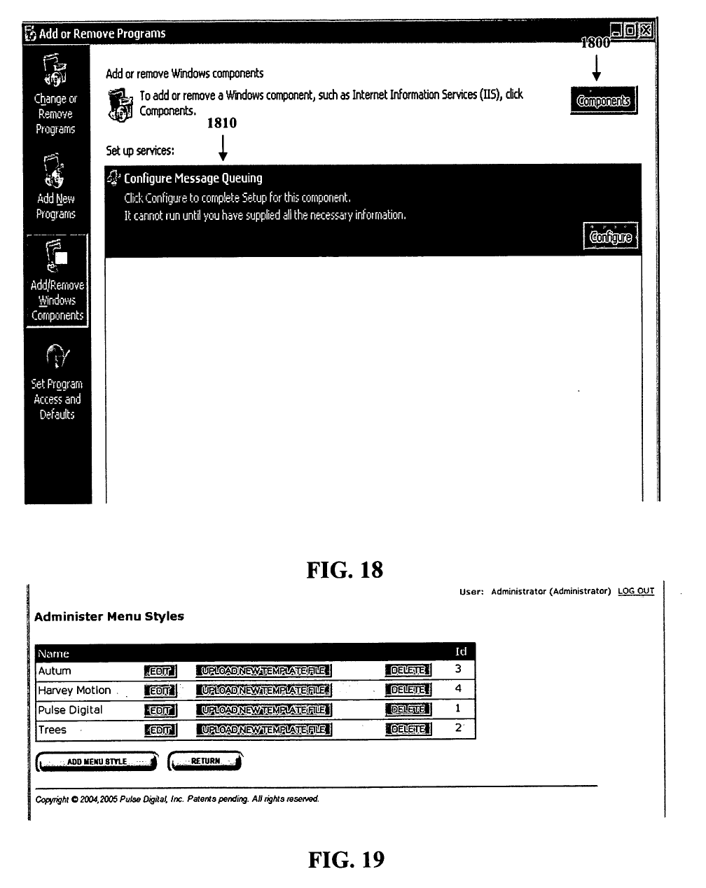

FIG. 18 illustrates an example of the screen presented to the user for adding and removing a component 1800 (e.g. message queueing) and configured service 1810 from the operating system upon which the inventive system runs.

The present invention additionally consists of a method for delivering the digital file to network-based robotic DVD recording & printing devices along with relevant metadata to achieve the following steps. The processing request is parsed into multiple discrete files, including the DVD image, a file providing the information required to produce the desired look for the external look of the DVD, and an XML file providing the delivery information. There is a proprietary communication protocol established between the invention's host server and a small application residing on a computer at the destination location. This computer may also be the control center for the remote DVD recorder/printer.

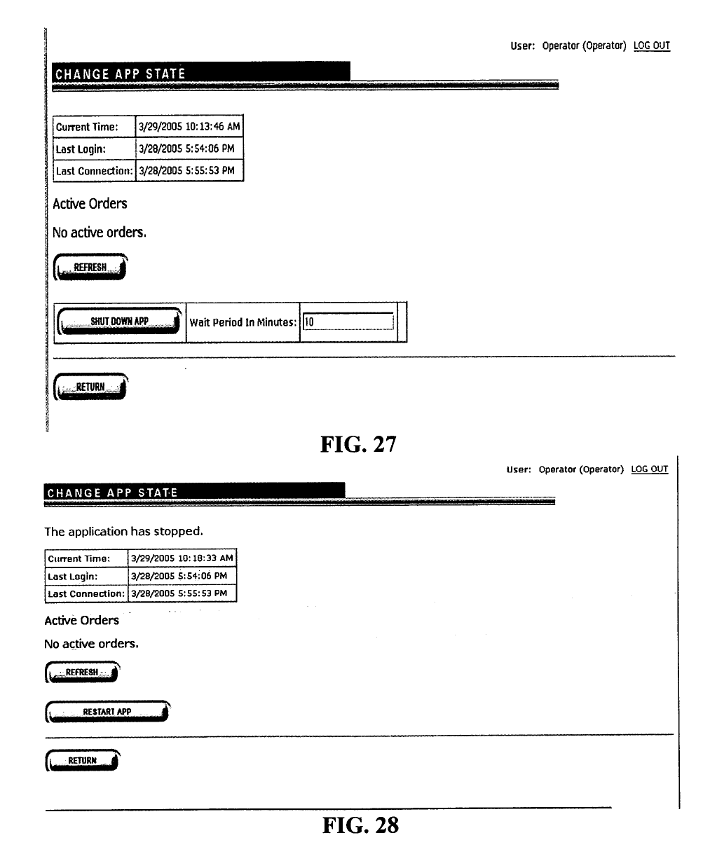

Given that the communication protocol referenced above informs the server of the status of the DVD fulfillment process, the system of the present invention also has a monitoring capability allowing individuals “herein referred to as operators” to access the status of all DVD recording and CD recording jobs to which the individual's user rights allow. Operators may monitor the status of the applications via exemplary screen interfaces in FIGS. 27 and 28.

The process described herein is part of a more expansive platform for distributing content from an asset management system. Wherein aforementioned steps relate to the production of authored DVDs and delivery on DVD and CD via a network, the larger platform relates to the automated delivery of content contained within the centralized repository. This includes the automatic conversion of video files and push out to other video-oriented devices such as Telestream's line of appliances for receiving video files.

Additionally, this platform will enable users of the centralized repository to select one or more media clips and distribute them to video-on-demand servers worldwide, in an automated fashion, along with requisite metadata to provide delivery and scheduling instructions. The automated method follows the same processes that the user manually performs, as referenced in steps 311, 305 through 310, and 312 through 315, respectively. This will enable users within a company utilizing a centralized media repository or repositories to select the desired media and push it out to a device for multicasting, unicasting or otherwise distributing the media on-demand. The pushed media will be accompanied by information including when the clips should play, how frequently, for whom, and when they self-destruct.

The inventive system includes the following components: an NDS kernel, including rudimentary asset management system; DVD SelectNet™ module; the XML processing module and a Rimage device module.

Once installed at a facility, the DVD SelectNet™ will monitor a particular folder for incoming requests submitted in the form of an XML document. The actual specifications of the XML document will be provided to all development partners. It is important to note that the DVD SelectNet™ “lives” on the network with components running as a web service without being attached to any other systems. Thus, multiple systems can send requests to the same DVD SelectNet™. This enables a company having multiple media asset management systems to fully use this system. (The analogy is how different computers running different applications may all send print requests to the same printer.)

The automated DVD SelectNet™ order element contains at least two required and three optional sub-elements, including a project, a printer, a sender, a receiver, and a shipper. The project consists of the content, play list, and format of the DVD. The printer is the printer or DVD “burner” to which the DVD order is sent. The sender is the person submitting the order. The receiver is the person receiving the order. The shipper is the person shipping the order.

Project

The AutoDVD Order project element has at least eleven optional attributes, including a plurality of order identifications that include an external system's primary and secondary identification for the order. The third attribute is a mediaSelector, which defines the type of media to be “burned” (i.e. a CDR or a DVDR). If a CDR is selected, the DVD image will be burned to a CD-R disc. If the DVDR media type is selected, the DVD image will be burned to a DVD-R disc. A default value representing the number of copies of discs to be burned and printed is set in the AutoDVD application configuration. The default value is normally set at 1, however, this may be overriden to suit the needs of the sender and/or receiver using the system.

In an additional embodiment of the present invention, the value is ignored for orders burned to an internal CD/DVD drive. In the case of internal “burns”, the inventive system will burn to any disc place in to the selected drive, as long as it has sufficient capacity.

The fourth optional attribute is the number of discs to be burned and printed for each project. The default value is set to 1. The number of copies cannot exceed the maximum specified in the application configuration of the system of the present invention. The fifth optional attribute is for any notes that a user inscribes for a particular order. The sixth optional attribute is emailSender, which contains at least two values, “true” and “false”. As with all defaults herein, the values are specified in the application configuration. If “true”, an email is sent to the sender of the order when the order is completed, provided that order-related emails are enabled within the system. emailReceiver and emailShipper are the seventh and eighth optional attribute. Each contains two values as described directly above, in which selection of the “true” value results in an order sent to the order receiver and order shipper when said order is completed.

The ninth operational attribute, waitforDataMode, operates in two modes, DataAvailable and FilesInDirectory. In the preferred embodiment of the present invention, the attribute signals that the system should wait for asset data to become available before starting order processing. In the DataAvailable mode, the system waits until all of the files listed in the project playlist become available before starting order processing. In the preferred embodiment, the application will wait indefinitely if no associated waitForDatTimeoutInterval attribute, as described below, is specified for the order. If the FilesInDirectory mode is enables, the system waits for files to be created in the directory specified in the waitforFilesDirPath attribute, as described below. The system will start processing the order after detecting that there has been no activity in the directory for the time period specified in the order's waitForDataTimeoutInterval attribute, automatically including all asset files in the directory in the order's play list.

The waitForDataTimeoutInterval attribute is optional if the ‘DataAvailable’ mode within the waitForDataMode attribute is selected, but becomes required if the ‘FilesInDirectory’ is selected. The waitForDataTimeoutInterval attribute is formatted in hh:mm:ss, where ‘hh’ is hours, ‘mm’ is minutes and 'ss’ is seconds (e.g. 00:10:00 for “10 minutes”). For the ‘DataAvailable’ mode, the interval represents the time period that the application should wait for all files in the play list to become available. The order will time out if any files are missing when the wait period expires. For ‘FilesInDirectory’ mdoe, the interval represents the amount of time the application should wait for a lull in activity in the directory specified in waitForFilesDirPath before starting order processing. The eleventh attribute, waitForFilesDirPath is required if the FilesInDirectory mode is enabled. Therein, the directory to which asset files for a “wait for files” order will be copied.

The Project sub-element of the AutoDVD order has its own plurality of sub-elements. The Project sub-element includes at least three required sub-elements and at least four optional sub-element. The required sub-elements are comprised of a MenuStyle, a LabelStyle, and a PlayList. The syle for the DVD playback menu is optimized within the MenuStyle sub-element. LabelStyle contains the style for the physical disc label. The third sub-element, PlayList, includes a list of clips to be included on the DVD. It should be noted that the PlayList sub-element also contains optional clip spacing setting. The optional sub-elements of the Project sub-element include the MotionMenuButtonDuration (MMBD), which represents the duration of the motion menu buttons. VideoSetting is a predefined combination of the bitrateinKbps and transcodeEffort attributes. If a video setting is specified, it will override any values specified by these attributes. MenuHierarchy is the menu hierarchy for the project. The Data attribute is directed to the files and directories (hereinafter designated as “data items”) to be added to a ‘Data’ directory in the DVD image's root directory.

Within the Project sub-element, there are a plurality of attributes further containing a plurality of values. The “title” is a required attribute, as it provides the title for the DVD to be burned and printed. Optional attributes are “subtitles”, wherein the default value is blank, “notes” for each project, “menuButtonStyle”, bitrateInKbps, transcodeEffort, and discStartAction.

The values within the “menuButtonStyle” attribute are pertinent to the type of buttons on the DVD playback menu (e.g. ThumbnailAndText, ThumbnailOnly, MotionVideoandText, and MotionVideoOnly). The ThumbnailandText value provides that the DVD playback menu will show both a thumbnail and the associated “menuButtonText” for each clip. In contrast, if the ThumbnailOnly value is selected, the DVD will show only the thumbnail for each clip. The effect of selecting the MotionVideoandText value is that the DVD playback menu will show motion video buttons and the associated “menuButtonText” for each clip. The duration of the motion videos is controlled by the optional MMBD sub-element heretofore described. The MotionVideoOnly value causes the DVD playback menu to show motion video buttons only. Defaults of these values are set in the DVD SelectNet™ system configuration.

The attribute for bitrateInKbps signifies the video output's bitrate in kbps (e.g. 2000-8000 for 2 mbps-8 mbps). Default value is defined in the DVD SelectNet™ system configuration. The transcodeEffort enables the amount of effort to be expended in transcoding clips (i.e. ‘Low’, ‘Medium’ or ‘High’). Default value is defined in the DVD SelectNet™ system configuration. A VideoSetting element in the same project will override any bitrateInKbps and transcodeEffort setting. The user must specify either VideoSetting, or bitrateInKbps and/or transcodeEffort, but not both.

The discStartAction enables the playback action to take at the start of playback via ‘ShowMenu’ or ‘PlayFirstClip”. If ‘ShowMenu’ is selected, playback starts with display of the top-level menu. ‘PlayFirstClip’ enables playback to start with the first clip in the play list. The ‘PlayFirstClip’ option is not allowed for projects with menu hierarchies, as the concept of a “first clip” is not applicable in that context. ‘PlayFirstClip’ is switched to ‘ShowMenu’ for projects with menu hierarchies. The default value is ‘ShowMenu’.

The MenuStyle sub-element of the Project sub-element is comprised of at least one required attribute, the refid. The refid is database identification of the style for the DVD's playback menu comprising a styleset name and a style name. For example, the “DefaultStyles/ExampleStyle” is an authoring plug in menu style, wherein “DefaultStyles” is a styleset name, and “ExampleStyle” is a style name. Defined menu styles are installation-specific. FIG. 20 is exemplary of an interface presented to the user for adding selected menu styles for storage within the inventive system. To obtain a list of valid style id's, within the ‘Administer Menu Styles’ page in the DVD SelectNet™ web application an ‘Id’ column appears in the list of defined menu styles.

The LabelStyle sub-element of the Project sub-element is also comprised of at least one required attribute, the refid, having a label style and a label template file name. Within this sub-element, the functionality of the refid is directed to a database identification of the style for the physical disc label. “EverestOne.btw” is exemplary of a Rimage label template file name for a Rimage plugin label style. Defined styles are also installation-specific within LabelStyle. An exemplary interface presented to a user to administer desired label styles can be seen in FIG. 21. The name 2100 and applicable field 2110 (e.g. title, subtitle, sender company name, and subtitle, etc.) for each label style are viewable within the interface along with specific buttons for editing 2111, uploading 2112 and deleting 2113 label styles, and an identification number 2114 for each label style.

The PlayList subelement of the Project sub-element has at least two optional sub-elements, wherein the selection of at least one of the optional sub-elements is required to implement the PlayList operation. ClipSpacing specifies the duration and color of the spacing between clips. Selection of the duration subelement is required and presents a choice to display the clip spacing in seconds or frames. Within the color attribute of ClipSpacing, colors are available in black, white or blue, with the default color being black. The default is set in the AutoDVD application configuration file. The ClipSpacing selection is ignored if the play list's “endofClipAction” variable is set to “ReturnToMenu”. “endofClipAction” is an attribute within the PlayList sub-element having three or more optional values, “PlayNextClip”, “ReturnToMenu”, and “PlayNextClipWithLoop”. When the PlayNextClip value is optimized, the next clip in the play list will be plated after the specified clip spacing. When the ReturntoMenu value is selected, the menu from which the clip was played is displayed. When the PlayNextClipWithLoop is selected, it functions the same as PlayNextClip, however, the playback loops back to the first clip in the current menu level when the last clip is completed.

The second sub-element, Clip, signifies that one or more clip elements specify the content and play order for the DVD disc. The functionality of the Clip sub-element is dependent on the selection of at least two required attributes and one optional attribute. A first required attribute displays the full network path to the clip's digital media file (i.e. mpg, .mov, or .jpg). It should be noted that the user account on which the AutoDVD application is running must be configured to have read access to this file. The Microsoft Windows system account that the DVD SelectNet™ app is running under (usually dvdsn_user) must have read access to this file. Network (UNC) paths are permitted. However, in the preferred embodiment of DVD SelectNet™, network files must be copied to the DVD SelectNet™ server before the authoring stage starts. The user should always specify a local path (e.g., “C{cube root} . . . ”) if the file is actually a local file. An order will be rejected if the extension for a specified clip path is not one of the application's recognized video or still extensions (specified in the ‘SupportedVideoFileExtensions’ or ‘SupportedStillFileExtensions’ properties, respectively, of the DVD SelectNet™ system configuration).

menuButtonText is the second required attribute, generating a short title for the clip that will appear on the DVD's playback menu. The display of the short title is dependent on the selection of ThumbnailandText for the project's menuButtonStyle attribute. The optional attribute, “type”, represents the type of the clip (i.e. Video or Still). The default is set to Video.

The optional MMBD sub-element of the Project sub-element provides a motion menu button loop duration as a number seconds or frames. In the preferred embodiment of the present invention, all menu button video loops start at the beginning of the clip. An additional embodiment of the present system allows for a user to override this feature by specifying an alternative offset on a project-wide or clip-by clip basis. The MMBD sub-element contains at least two required attributes, unit and count. The unit attribute sets forth whether seconds or frames are used to represent the duration of the motion menu button loop. The count attribute further modifies the unit attribute to show the number of units used in the duration. A count of 0 will eliminate any spacing between clips when they are played back-to-back. As described herein, the MMBD sub-element is only functional is the MotionVideoAndText or MotionVideoOnly menu button style values are selected for the project.

Within the Clip sub-element, there is a PropertyValue element, which defines a property value for a clip. Property values need only be specified for projects that have hierarchical menus defined (see ‘MenuHierarchy’ element below). You create hierarchical menus by: 1) Assigning property values to clips using ‘PropertyValue’ elements, 2) Defining a project ‘MenuHierarchy’ element with one or more levels for the assigned properties. The PropertyValue element has two required attributes, name and value. The name of the property is the first required attribute (e.g. “Manufacturer”. This is the name that you use as the property name in a menu hierarchy's ‘Level’ element, described herein below. The second attribute is the value for the property (e.g. “Procter & Gamble”, “Lever Brothers”, etc.)>

The ‘MenuHierarchy’ element defines the project's menu hierachy. A menu hierarchy defines one or more menu levels based on clip properties. For example, a user can define a menu hierachy that groups clips by ‘ProductType’ (e.g. soap, shampoo, deodorant, hairspray, etc.) and ‘Manufacturer’ (e.g. Procter & Gamble, Lever Brothers, etc.) or properties, where ‘Manufacturer’ submenus are nested within ‘ProductType’ menus. The user assigns a ‘ProductType’ and a ‘Manufacturer’ property value to each clip in the play list. These values determine which product type X manufacturer submenu the clip will appear in. The Project element has two subelements, level and format. Within the level subelement, one or more levels, each of which defines a menu hierarchy level, are specified in order of highest level to lowest level. At least one level is required. The formatting specifications for the menu hierarchy are optional.

A menu hierarchy ‘Level’ element defines a level in a project's menu hierarchy. Property is the clip property for this menu hierarchy level. All clips in the project's play list. It is required and should include a ‘PropertyValue’ element for this property. A Menu style for this menu hierarchy level is optional. The Default value is the default menu style set in the ‘Edit App Data’ page of the Dvd SelectNet™ web application. The name of the property is required. A user may optionally implement the type of the property (i.e. ‘String’, ‘Int16’, or ‘Int32’). The default is set to ‘String’. A user implements ‘Int16’ or ‘Int32’ for numeric values to ensure that property values sort correctly. If ‘String’ is used for numeric values, property values will not sort correctly. For example, “10”, “11”, “12”, . . . will be less than “2”, so values 1-10 will sort “1”, “10”, “2”, . . . . The user must specify ‘Int16’ for 16-bit integer values (1-32, 767) and ‘Int32’ for 32-bit integer values (e.g. 1-2, 147, 483, 647).

“isMultiValue” is an optional attribute that defines whether or not the property can have multiple values (i.e. ‘true’ or ‘false’). The default is ‘false’. A clip can have more than one for the same property, provided that the isMultiValue attribute is set to ‘true’ for that property. If a clip has multiple values for a multi-valued property, it will appear in multiple menus for that property.

The ‘Format’ element of a menu hierarchy level controls how menu titles and sub-menu button titles are formatted for that level. There are at least three optional attribute, titleType, valueType, and missingValueText. titleType controls how the title for a menu level is formatted (i.e. ‘TitleOnly’, ‘ValueOnly’, ‘AllValuesOnly’, ‘TitleAndValue’, or ‘TitleAndAllValues’). The following example assumes the project title is “Sample Reel”, the menu hierarchy is ‘Product Type’ X ‘Manufacturer’, and the current menu is for ‘Soap’ X ‘Procter & Gamble’. ‘TitleOnly’ only shows the project title (example: “Sample Reel”). ‘ValueOnly’ only shows the value for the current menu level's property (example: “Procter & Gamble”); ‘AllValuesOnly’ shows property values for all parent menus and the current menu example: “Soap—Procter & Gamble”). ‘TitleAndValue’ shows the project tile and the current menu levels's property value (example: “Sample Reel: Procter & Gamble”). ‘TitleAndAllValues’ shows the project title and the property values for all parent menus and the current menu (example: “Sample Reel: Soap—Procter & Gamble”). The Default value is defined in the system configuration.

valueType controls how property values are formatted: without the property name, or with the property name—‘ValueOnly’ or ‘PropertyNameAndValue’. ‘ValueOnly’ only shows the property value (e.g. “Procter & Gamble”).

‘PropertyNameAndValue’ shows the property name and the value (e.g. “Manufacturer: Procter & Gamble”). The default value is defined in the DVD SelectNet™ system configuration.

missingValueText is the text to be used for missing values.

A separate “missing value” submenu will contain any clips that are missing a value for the menu hierarchy level's property. The missingValueText attribute specifies the name to be used for that submenu. The default value is defined as described above.

Printer

The printer element of the AutoDVDOrder component of the inventive system contains an attribute, pluginID, which is a plugin-specific identification of the printer or “burner” to which to send the order. For example, a sender may select DefaultProductionCluster/Rimage_{—}0001/Any for a Rimage plugin printer, where “DefaultProductionCluster” is a Rimage cluster name, “Rimage_{—}0001” is the server and “Any” represents the printer number on the server. Defined printers must be specified in the installation phase.

Sender

The sender element supplies information about the person submitting the order to be used in generating the physical DVD label and for accounting purposes. The sender element comprises a plurality of sub-elements and at least one optional attribute. At least two sub-elements, Name and ContactInfo, are required. The Name sub-element stores the name 900 of the sender. The Name element consists of at least two required and one optional attribute for directed to the input and storage of information pertaining to the first, last and middle name of the sender, respectively. The default entry for the middleinitial attribute is blank. The username attribute is optional, and governs the AutoDVD application username 910 for the sender. The default entry for this attribute is blank. If the sender is registered as a user in the AutoDVD application, the sender is assigned an AutoDVD application username 910. If the username 910 is specified, said sender can log into the application under username 910 and may access the “View Orders” page to view the status of any orders that he/she has previously completed.

ContactInfo stores contact information, including but not limited a plurality of required sub-elements for the company location, phone number and email address of the sender. CompanyLocation sub-element comprises at least two required and one optional inputs. The Company and Address inputs prompt a user to provide the name 1000 and address of the company sending or receiving the order. The PhoneNumber input is optional. An optional description attribute is allocated to the company information wherein a user can provide a description of choice for the company for which he or she works. The description attribute defaults to the company name. The sender may also create an abbreviated name 1010 for the company, and may add the URL address 1020 for the company's website as well.

Receiver

The receiver element comprises a plurality of sub-elements and at least one optional attribute. At least two sub-elements, Name and ContactInfo, are required. The Name sub-element stores the name 900 of the receiver. ContactInfo stores contact information, including but not limited to the company location, phone number and email address of the receiver. The username attribute is optional, and governs the AutoDVD application username 910 for the receiver. The default entry for this attribute is blank. If the receiver is registered as a user in the AutoDVD application, the receiver is assigned an AutoDVD application username 910. If the username is specified, said receiver can log into the application under username 910 and may access the “View Orders” page to view the status of any orders that he/she is receiving.

Shipper

The shipper element comprises a plurality of sub-elements and at least one optional attribute. At least two sub-elements, Name and ContactInfo, are required. The Name sub-element stores the name 900 of the receiver. ContactInfo stores contact information, including but not limited to the company location, phone number and email address of the shipper.

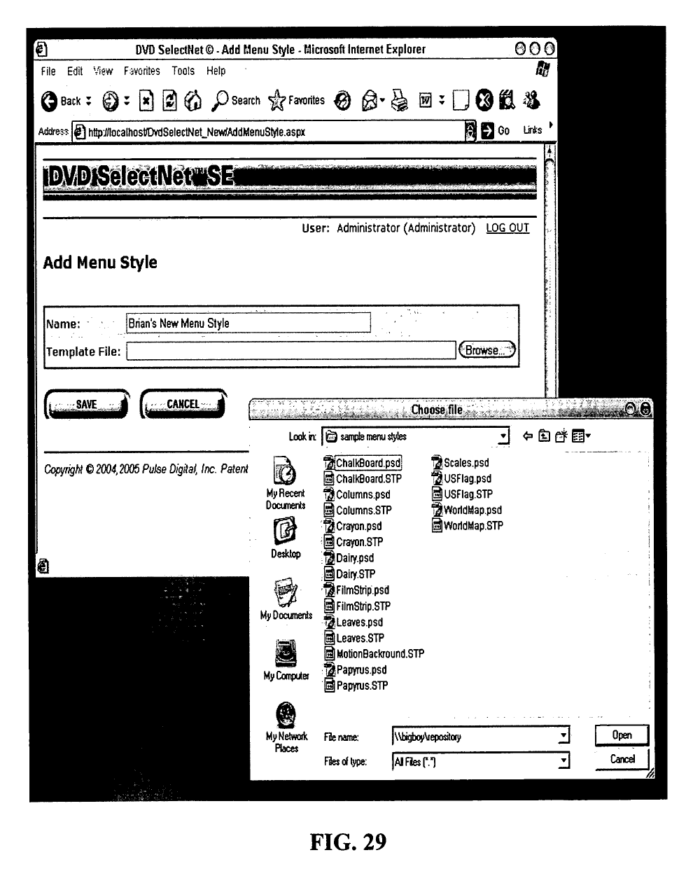

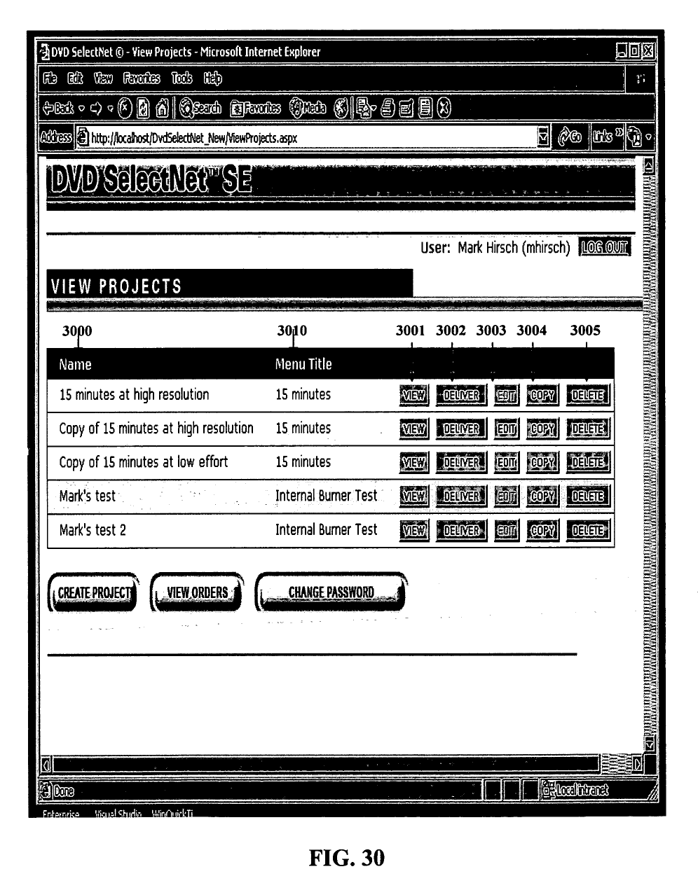

FIGS. 29 through 32 illustrate examples of interfaces presented to users accessing the DVD Select Net™ inventive system via the Internet. FIG. 29 depicts a menu style creation interface in which a user searches among a plurality of template or sample menu styles, and selects a style to which a name is assigned for future use. FIG. 30 is an exemplary web browser screen of the project viewing interface. Therein, the user can view the assigned name 3000 of the project along with the menu title 3010 designated for the project. As in FIG. 22, the user is presented with the options to select among viewing 3001, delivery 3002, editing 3003, copying 3004, and deletion 3005 buttons in order to perfect the desired content and design of the ordered DVD.

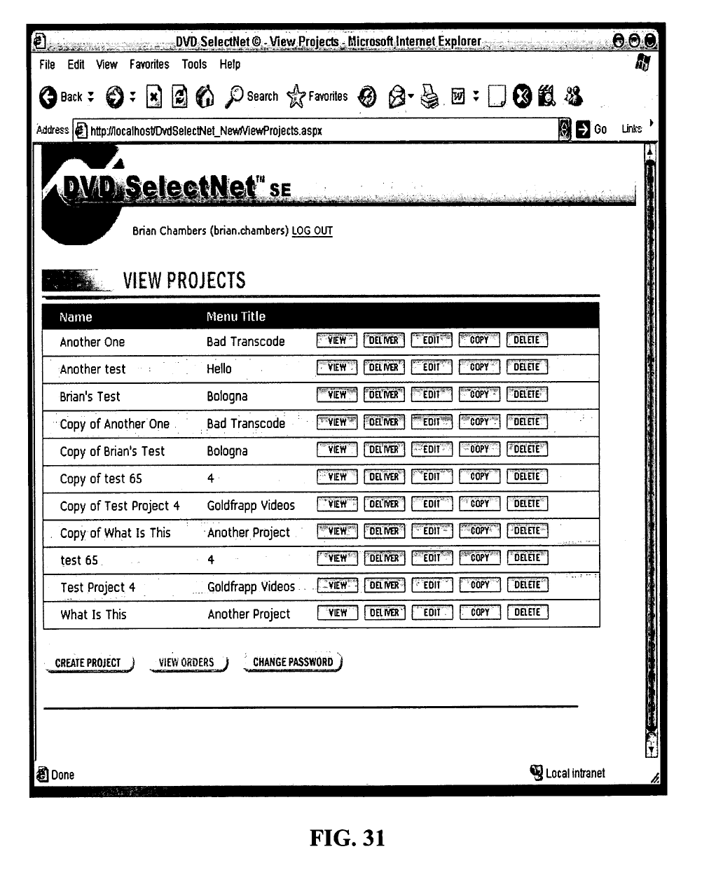

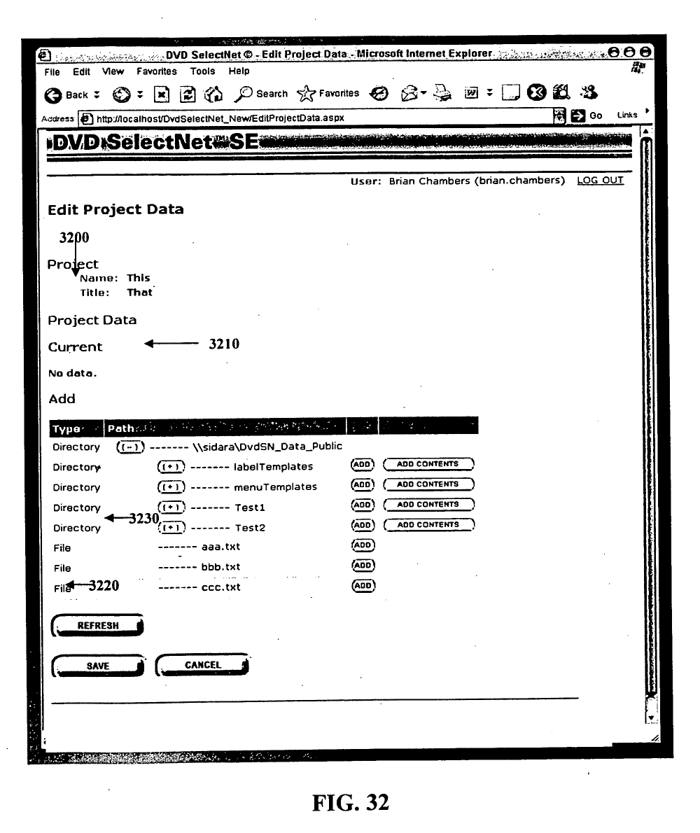

Similarly, FIG. 31 presents another view of a project viewing interface that reflects the projects created and stored by an additional user. Finally, FIG. 32 illustrates a project data interface presented to an Internet user. Within this interface, the user may view the names of files 3220 and directories 3230 in which the media and metadata (i.e. project data 3210) are stored for the desired project 3200.

Alternatively, the system may be supplied with additional components, including but not limited to a delivery mechanism to Telestream ClipMail devices, delivery of other video formats to FTP, delivery to automated tape-based backup systems, delivery to PowerPoint formats (one video clip per slide, submission from an Avid Technologies editing system, submission from an Apple Computer editing system, and automated delivery from an editing system (such as from Avid Technologies or Apple Computer) directly to DVD SelectNet™ and out to DVD disc.

In an additional embodiment of the present invention, the digital video disc image described above can be created at the application server and distributed over any network including the Internet, specifically to one or more destinations, including individual users. The distribution of said image can be distributed to at least one individual receiving user over the Internet. The system of the present invention notifies the receiving user of the delivery of the digital video disc image and prompts the at least receiving user, via ejection of a digital video disc tray within the receiving user's recording device, to insert a media disc (i.e. a DVD or CD) for the recording of the distributed digital video disc image.

It will be readily apparent to those skilled in the art that various changes and modifications of an obvious nature may be made, and all such changes and modifications are considered to fall within the scope of the appended claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

1. A system for automated digital video disc recording and printing, said system comprising:
(a) a media repository connected to a wide area or local area network;
(b) a server for extracting and storing digital data from the media asset management system for the compilation of client-desired digital video disc projects, wherein the server is operationally linked to the network;
(c) a digital video disc recording device for receiving said projects from the server;
(d) a digital video disc printing device for printing and affixing a label on to a digital video disc; and
(e) at least one client computing apparatus connected to the network, wherein the digital video disc recording device and printing device may be physically attached to a client computing apparatus and alternatively remotely attached to a client computing apparatus via the network.

2. The system of claim 1, wherein the client computing apparatus is operated by a user to access the media repository and server.

3. The system of claim 1, wherein the client computing apparatus is operated by a sender, a shipper and a receiver.

4. The system of claim 1, wherein the media repository contains media and metadata information.

5. The system of claim 1, wherein the at least one client computing apparatus communicates with external media asset management systems through an extensible markup language order protocol to obtain media and metadata information.

6. The system of claim 1, wherein the server archives the media for the creation and recording of a digital video disc.

7. The system of claim 1, wherein the server archives the metadata information for printing a digital video disc label on the digital video disc printing device.

8. The system of claim 1, in which the server compiles the media into a playlist, wherein said server transcodes the media into a suitable format for recording a digital video disc project, and builds menu pages for navigation of the project, and transmits the project to the digital video disc recording device for recording.

9. A system for automated digital video disc recording and printing, said system comprising:
(a) a wide area or local area network capable of receiving data from and transmitting data to at least one remotely situated client computing apparatus;
(b) a media repository connected to said network;
(c) a server for extracting and storing digital data from the media asset management system for the compilation of client-desired digital video disc projects, wherein the server is operationally linked to the network;
(d) a digital video disc recording device for receiving said projects from the server;
(e) a digital video disc printing device for printing and affixing a label on to a digital video disc; and
(f) at least one client computing apparatus capable of remotely connecting to the network, wherein the digital video disc recording device and printing device may be physically attached to a client computing apparatus and alternatively remotely attached to a client computing apparatus via the network; and further wherein the at least one remotely connected client computing apparatus receives a digital video disc image for recording via the attached digital video disc recording device.

10. The system of claim 9, wherein the client computing apparatus is operated by a user to access the media repository and server.

11. The system of claim 9, wherein the client computing apparatus is operated by a sender, a shipper and a receiver.

12. The system of claim 9, wherein the media repository contains media and metadata information.

13. The system of claim 9, wherein the at least one client computing apparatus communicates with external media asset management systems through an extensible markup language order protocol to obtain media and meta data information.

14. The system of claim 9, wherein the server archives the media for the creation and recording of a digital video disc.

15. The system of claim 9, wherein the server archives the metadata information for printing a digital video disc label on the digital video disc printing device.

16. The system of claim 9, in which the server compiles the media into a playlist, wherein said server transcodes the media into a suitable format for recording a digital video disc project, and builds menu pages for navigation of the project, and transmits the project to the digital video disc recording device for recording.

17. A method for digital video disc recording and printing, said method comprising:
(a) collecting media data elements and metadata information from a media asset management system;
(b) maintaining the media data elements and metadata in a database within the media asset management system;
(c) receiving the media and metadata into a designated server;
(d) selecting media and digital video disc configurations via an HTML interface;
(e) creating a digital video disc project from the selected configurations;
(f) submitting a digital video disc project order for storage within the server's database;
(g) verifying the order;
(h) transcoding the media to a specified digital video disc format;
(i) designing a menu page for the digital video disc project;
(j) programming menu button functionality on the menu page;
(k) programming navigation of the digital video disc project;
(l) creating a digital video disc image;
(m) sending the image to a local or remote digital video disc recorder;
(n) recording the image;
(o) using the metadata information to print a disc label; and
(p) sending an email notification to selected users.

18. The method of claim 17, wherein the selected users are a sender, receiver and shipper.

19. A method for automated digital video disc recording and printing, said method comprising:
(a) collecting media data elements and metadata information from a media asset management system;
(b) maintaining the media data elements and metadata in a database within the media asset management system;
(c) receiving the media and metadata into a designated server;
(d) specifying media and digital video disc configurations;
(e) submitting an XML order for the digital video disc project from the specified configurations;
(f) verifying the order;
(g) transcoding the media to a specified digital video disc format;
(h) designing a menu page for the digital video disc project;
(i) programming menu button functionality on the menu page;
(j) programming navigation of the digital video disc project;
(k) creating a digital video disc image;
(l) sending the image to a local or remote digital video disc recorder;
(m) recording the image;
(n) using the metadata information to print a disc label; and
(o) sending an email notification to selected users.

20. The method of claim 19, wherein the selected users are a sender, receiver and shipper.
